(19) United States
(12) Patent Application Publication
(10) Pub. No.: US 2009/0146548 A1
(43) Pub. Date: Jun. 11, 2009

(54) Device for Illuminating Using Blue, Green, Yellow, or Red Light Emitting Diodes

(75) Inventors: Hans Lichtenstein, Reinheim (DE); Damrien Machert, Riedstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK ROEHM GMBH, Darmstadt (DE)

(21) Appl. No.: 12/084,991

(22) PCT Filed: Nov. 9, 2006
(86) PCT No.: PCT/EP2006/068280

§ 371 Date: Oct. 7, 2008

(30) Foreign Application Priority Data
Nov. 14, 2005 (DE) 10 2005 054 591.2

(51) Int. Cl. H01J 1/62

(52) U.S. Cl. 313/503; 313/512

(57) ABSTRACT

The invention relates to an apparatus for illumination with blue, green, yellow or red light-emitting diodes (LEDS), comprising one or more coloured LEDs and a light-scattering cover associated with the LED colour and composed of coloured plastic and having a base colour derived from one or more non-fluorescent dyes, characterized in that the light-scattering cover comprises, in addition to the base colour, at least one fluorescent dye associated in terms of colour with the base colour, where the dye mixture has been adjusted in such a way that the reflectance of the light-scattering cover is at least 28% at the wavelength of the energy maximum of the LED(S) used, where, based on the standard chromaticity diagram and on the colour loci of the reflected light from the light-scattering cover and on the colour locus of the LED(s) used, the following alternative relationship applies to the absolute value of the difference between the x value of the light-scattering cover and the x value of the LED and the absolute value of the difference between the y value of the light-scattering cover and the y value of the LED:
a) for blue LED illumination: absolute value for x smaller than 0.03/absolute value for y smaller than 0.05
b) for green LED illumination: absolute value for x smaller than 0.05/absolute value for y smaller than 0.08
c) for yellow LED illumination: absolute value for x smaller than 0.0025/absolute value for y smaller than 0.02
d) for red LED illumination: absolute value for x smaller than 0.03/absolute value for y smaller than 0.003.

The invention relates to an apparatus for illumination with blue, green, yellow or red light-emitting diodes (LEDs), composed in essence of a LED light source and of a light-scattering cover associated with the light source and composed of coloured plastic.

### PRIOR ART

Illuminable apparatuses are in principle known (see, for example, JP 61159440), for example for advertising panels composed in essence of a light source and of a light-scattering cover associated with the light source and composed of coloured plastic. The light sources generally used comprise incandescent lamps or fluorescent tubes, these having good luminosity and emitting a broad spectrum of light. By virtue of the broad spectrum of light, the perceived colour of corresponding coloured plastics covers without illumination, i.e. in daylight, is the same as that perceivable on backlighting by the light sources mentioned.

Light-emitting diodes have markedly less luminosity when compared with light sources such as incandescent lamps or fluorescent tubes. However, coloured light-emitting diodes can nevertheless be very easily perceived in the dark because they emit light which is in essence, or almost, monochromatic, in turn being relatively intensive in the respective wavelength region. Corresponding coloured light-emitting diodes are available from a plurality of producers, e.g. in red, green, blue and yellow colours.

Colours and colouring processes for plastics, e.g. polymethyl methacrylate, are well known, e.g. from EP-A 130 576.

WO 03/052315 describes an illuminable apparatus, composed in essence of a light source and of a light-scattering cover associated with the light source and composed of coloured plastic, characterized in that the light source is composed of one or more light-emitting diodes (LEDs) which emit coloured, in essence monochromatic, light, and in that the transmittance (DIN 5036) of the associated light-scattering cover at the wavelength of the relative energy maximum of the light-emitting diode is at least 35% and its reflectance (DIN 5036) is at least 15%. According to WO 03/052315, the object achieved is that of providing an alternative to the known illuminable apparatus in which coloured covers composed of plastic are back-lit by means of incandescent lamps or fluorescent tubes. The light-scattering cover is coloured here by means of non-fluorescent dyes and, respectively, colorants. A particular optical property of the apparatus is that it can give approximately the same perceived colour when front-lit, e.g. in daylight, and also when back-lit. Because LEDs are used, the apparatus can also give apparatuses with smaller installation depth and smaller electricity consumption than conventionally illuminated apparatuses.

### OBJECT AND ACHIEVEMENT OF OBJECT

An optical property of the illuminable apparatuses according to WO 03/052315 is that they can give approximately the same perceived colour when front-lit, e.g. in daylight, and also when back-lit. An object was to develop the apparatuses according to WO 03/052315 further in such a way that the perceived colour either in daylight or with back-lighting appears even more brilliant, without any resultant significant deviations in the two perceived colours. The object is achieved via an apparatus for illumination with blue, green, yellow or red light-emitting diodes (LEDs), comprising one or more coloured LEDs and a light-scattering cover associated with the LED colour and composed of coloured plastic and having a base colour derived from one or more non-fluorescent dyes, characterized in that the light-scattering cover comprises, in addition to the base colour, at least one fluorescent dye associated in terms of colour with the base colour, where the dye mixture has been adjusted in such a way that the reflectance of the light-scattering cover is at least 28% at the wavelength of the energy maximum of the LED(s) used, where, based on the standard chromaticity diagram and on the colour loci of the reflected light from the light-scattering cover and on the colour locus of the LED(s) used, the following alternative relationship applies to the absolute value of the difference between the x value of the light-scattering cover and the x value of the LED and the absolute value of the difference between the y value of the light-scattering cover and the y value of the LED:
a) for blue LED illumination: absolute value for x smaller than 0.03/absolute value for y smaller than 0.05
b) for green LED illumination: absolute value for x smaller than 0.05/absolute value for y smaller than 0.08
c) for yellow LED illumination: absolute value for x smaller than 0.0025/absolute value for y smaller than 0.02
d) for red LED illumination: absolute value for x smaller than 0.03/absolute value for y smaller than 0.003.

The basis of the invention comprises appropriate adaptation, to the monochromatic light of the LED used, of the transmittance and the reflectance of the light-scattering cover composed of plastic, in a manner similar to that described in WO 03/052315, in such a way as to permit almost the same perceived colour to be obtained with front-lighting and with back-lighting. For simplicity here, the colour locus of the transmitted light of the light-scattering cover is equated with the colour locus of the LED (x_{LED}/Y_{LED}), since the light of the LED is monochromatic and is practically unaltered by the light-scattering cover. The achievement of the invention here, via the addition of the fluorescent dye with simultaneous appropriate adjustment of the base colour, is to go beyond WO 03/052315 in bringing the colour locus of the reflected light of the light-scattering cover ((x_{reflected}/y_{reflected}) with incident light) close to the colour locus of the LED ((x_{LED}/y_{LED}) during illumination). With knowledge of the present invention, a person skilled in the art can undertake the corresponding appropriate adjustments of colour. Corresponding advertising panels or information panels have approximately the same appearance both during daytime and when back-lit. In comparison with WO 03/052315, there has generally been a marked increase in the reflectance value here and the reflected light is always closer to the corresponding colour locus of the LED, whereas there has been no alteration, or only an insignificant alteration, in the values for transmittance and the colour locus of transmitted light. The perceived appearance both during daylight and at night is markedly brighter and more brilliant and with this more attractive to the user.

The inventive equipment makes it possible to give the apparatus a markedly brighter and more brilliant appearance with the same electricity consumption, or to achieve an effect which is at least equivalent to that in WO 03/052315 with reduced electricity consumption. The inventively illuminable apparatuses require smaller installation depths, because LEDs are smaller than corresponding incandescent lamps or fluorescent tubes. In comparison with WO 03/052315, it is possible to reduce the number of LEDs present, and with this it becomes even easier to realize complicated designs. Electricity consumption is smaller for almost identical visibility when back-lit. Because LEDs can be operated using low voltages, the electrical safety of the inventive apparatuses is greater or is easier to ensure. Maintenance cost is likewise smaller, because LEDs generally require less frequent replacement than other means of illumination, e.g. fluorescent tubes.

### FIGURES

The invention is explained via the figures below, but without any restriction to the embodiments shown.

FIG. 1/2:

Reflectance spectrum of three coloured, light-scattering plastic sheets on illumination with a green LED whose relative energy maximum is at about 520 nm. (constitutions: see Examples 1-3, green 1-3)

3=green 3: only base colour (prior art according to WO 03/052315)

1=green 1: base colour+fluorescent dye (inventive)

2=green 2: base colour+fluorescent dye+TiO₂ addition (inventive)

FIG. 2/2:

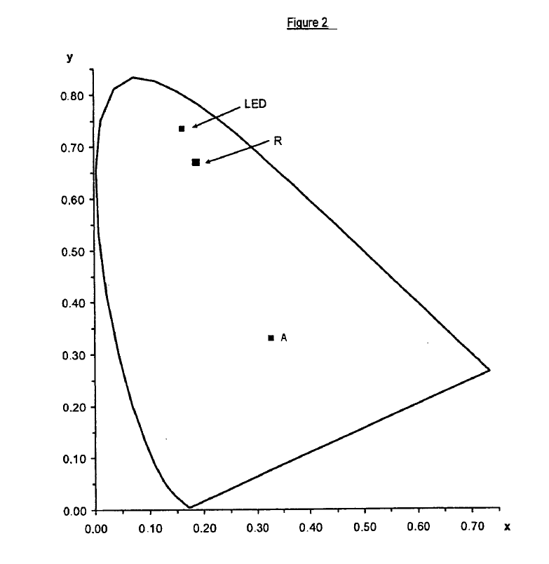

Standard chromaticity diagram

A=achromatic point (x/y=0.33/0.33)

LED=colour locus of a green LED (x_{LED}/y_{LED})

R=colour locus of reflected light from a light-scattering cover (x_{reflected}/y_{reflected})

### BRIEF DESCRIPTION OF THE INVENTION

### Apparatus

The invention provides an apparatus for illumination with blue, green, yellow or red light-emitting diodes (LEDs), comprising one or more coloured LEDs and a light-scattering cover associated with the LED colour or the colour locus of the LED during illumination and composed of coloured plastic and having a base colour derived from one or more non-fluorescent dyes, characterized in that the light-scattering cover comprises, in addition to the base colour, at least one fluorescent dye associated in terms of colour with the base colour, where the dye mixture acts or has been adjusted in such a way that the reflectance of the light-scattering cover is at least 28% at the wavelength of the energy maximum of the LED(S) used, where, based on the standard chromaticity diagram (DIN 5033) and on the colour locus of reflected light from the light-scattering cover ((x_{reflected}/y_{reflected}) with incident light) and on the colour locus of the LED ((x_{LED}/y_{LED}) during illumination), the following alternative relationship applies to the absolute value of the difference (absolute value x_{diff}) between the x value of the light-scattering cover (x_{reflected}) and the x value of the LED (x_{LED}) and the absolute value of the difference (absolute value y_{diff}) between the y value of the light-scattering cover (y_{reflected}) and the y value of the LED (y_{LED}):
a) for blue LED illumination: absolute value x_{diff} smaller than 0.03/absolute value y_{diff} smaller than 0.05
b) for green LED illumination: absolute value x_{diff} smaller than 0.05/absolute value y_{diff} y smaller than 0.08
c) for yellow LED illumination: absolute value x_{diff} smaller than 0.0025/absolute value y_{diff} smaller than 0.02
d) for red LED illumination: absolute value x_{diff} smaller than 0.03/absolute value y_{diff} smaller than 0.003.

The only important factor here is the absolute difference or, respectively, the distance between the x and, respectively, y values, rather than their relative position in the standard chromaticity diagram. The intention is that this difference or distance be minimized and ideally be almost zero or zero. However, the intention is that it at least does not exceed the upper limits stated above. It is moreover of no significance whether calculation of the difference between the corresponding x and, respectively, y values leads mathematically to a positive or to a negative value. For this reason, the invention is based on the absolute value of the difference between the x value of the light-scattering cover and the x value of the LED and on the absolute value of the difference between the y value of the light-scattering cover and the y value of the LED. When the present invention is used it becomes advantageously possible to undertake very close appropriate adjustment of the colour locus of the reflected light from the light-scattering cover to the colour locus of the LEDs used during illumination. This method provides illuminable apparatuses whose perceived colour is substantially the same in the unilluminated and illuminated state and is at the same time very brilliant.

The invention provides an illuminable apparatus, comprising a light source in the form of one or more coloured light-emitting diodes (LEDs) and provides a light-scattering cover associated with the light source and composed of coloured plastic. The apparatus is therefore in essence composed of the constituents vital for the function, namely of the light source and of the light-scattering cover associated with the light source and composed of coloured plastic. Other elements which, however, are not critical for the inventive functionality can moreover be present, e.g. a frame, housings, or fastening elements, etc.

The design of the apparatus can be such that the LEDs and the light-scattering cover have been associated with one another with a separation of from 3 to 12 cm, preferably from 4 to 10 cm. This separation achieves good illumination. If the separation is too small, the position of LED becomes visible in the form of a bright spot. If the separation is too great there is an excessive fall in brightness.

Location of the LEDs can, for example, be in a box or frame, covered by the light-scattering cover, e.g. in sheet form. The cover can be provided with an information-bearing layer, e.g. a foil, or can itself intrinsically take the form of information, e.g. in the form of letters or of numerals.

### GENERAL EXAMPLE

The following general example illustrates an inventive apparatus for yellow LED illumination and its principle is also applicable to blue, green or red LED illumination.

The colour locus of a yellow-illuminating LED can, for example, be x_{LED}=0.5/y_{LED}=0.5. The colour locus of the reflected light of a yellow-coloured, light-scattering cover whose colour locus has been appropriately adjusted in accordance with the invention (e.g. yellow 1 with a reflectance value of 40%, see in particular Example 1 and Tables 4 and 6) can, for example, be x_{reflected}=0.498/y_{reflected}=0.485. The following relationship applies to the absolute value of the difference, absolute value x_{diff}, between the x value of the light-scattering cover (x_{reflected}) and the x value of the LED (x_{LED}) and the absolute value of the difference, absolute value y_{diff}, between the y value of the light-scattering cover (y_{reflected}) and the y value of the LED (y_{LED}):

absolute value x_{diff}=x_{reflected} minus x_{LED}=0.498−0.5=0.002. The value is smaller than 0.0025 and is therefore within the range demanded according to the invention.

absolute value y_{diff}=y_{reflected} minus y_{LED}=0.485−0.5=0.015. The value is smaller than 0.02 and is therefore within the range demanded according to the invention. The corresponding apparatus is therefore inventive.

The absolute values x_{diff} and y_{diff} for other colours can be calculated analogously.

Light Source

The light source is composed of one or more, or of many, coloured light-emitting diodes (LEDs). If appropriate, it is also possible to make simultaneous use of LEDs of different colour.

Coloured LEDs have markedly less luminosity when compared with light sources such as incandescent lamps or fluorescent tubes. However, coloured LEDs can nevertheless be very easily perceived in the dark because they emit light which is in essence, or almost, monochromatic, in turn being relatively intensive in the respective wavelength region. Corresponding coloured LEDs are available from a plurality of producers, e.g. in red, green, blue and yellow colours. LEDs emitting white light are unsuitable for the purposes of the invention because these do not produce almost monochromatic light but instead produce a broad spectrum of light similar to that of a conventional incandescent lamp.

Coloured light-emitting diodes LEDs emit light which is almost, or in essence, monochromatic. The expression “almost, or in essence” monochromatic light here is intended to express the fact that the light from commercially available LEDs is often termed monochromatic for simplification and for contrast with other, standard light sources, although this is not strictly the case. In practice, the wavelength spectrum of a coloured LED has a narrow, peak-like distribution. Alongside the wavelength characteristic of the respective LED representing the relative energy maximum (peak maximum), there are always also adjacent wavelengths present with relatively low intensity. A person skilled in the art would therefore call the light from coloured LEDs almost or in essence monochromatic.

The colour of the LED here depends on the wavelength of its relative energy maximum. This relative energy maximum can, for example, be determined spectrophotometrically and can be indicated within a wavelength spectrum. The light source can, for example, be introduced into an Ulbricht sphere (see DIN 5036) and the emitted light can be measured. The highest point (peak) on the curve here indicates the wavelength of the relative energy maximum.

The number of the LEDs depends on the size of the apparatus, on the luminosity of the LEDs used and on the desired total brightness of the apparatus when back-lit. By way of example, LEDs are available in the form of modules each comprising 4 LEDs in a holder, and it is possible, if appropriate, to incorporate many of these into the apparatus.

Light-Emitting Diodes (LEDs)

Examples of suitable LEDs are commercially available red, blue, yellow or green LEDs.

A red LED has a relative energy maximum in the range from about 610 to 640 nm. The colour locus of a LED emitting red light, for example, can be about x=0.67 and y=0.33 during illumination.

By way of example, the red LED (Osram LM03-B-A) has a relative energy maximum at about 620 nm.

A blue LED has a relative energy maximum in the range from about 440 to 500 nm. The colour locus of a LED emitting blue light, for example, can be about x=0.14 and y=0.06 during illumination.

By way of example, the blue LED (Osram LMO3-B-B) has a relative energy maximum at about 460 nm.

By way of example, the blue LED (ESS Blue) has a relative energy maximum at about 475 nm.

A yellow LED has a relative energy maximum in the range from about 570 to 610 nm. The colour locus of a LED emitting yellow light, for example, can be about x=0.5 and y=0.5 during illumination.

By way of example, the yellow LED (Osram LM03-B-Y) has a relative energy maximum at about 590 nm.

A green LED has a relative energy maximum in the range from about 500 to 540 nm. The colour locus of a LED emitting green light, for example, can be about x=0.16 and y=0.73 during illumination.

By way of example, the green LED (Osram LM03-B-T) has a relative energy maximum at about 520 nm.

Light-Scattering Cover Composed of Plastics

Plastics

The light-scattering cover is composed of plastic, preferably of a thermoplastic or of a thermoelastic plastic. It is preferable that the plastic used is translucent or transparent in the uncoloured state. Suitable plastics can, for example, be:

polymethyl methacrylate (cast or extruded), impact-modified polymethyl methacrylate, polycarbonate, polystyrene, styrene-acrylonitrile, polyethylene terephthalate, glycol-modified polyethylene terephthalate, polyvinyl chloride, transparent polyolefin, acrylonitrile-butadiene styrene (ABS) or a mixture (blend) of various thermoplastics.

Base Colour

The light-scattering cover composed of plastic has a base colour, i.e. a colour derived from one or more non-fluorescent dyes. This type of colour is in principle known from WO 03/052315, although not in the form of the appropriate inventive adjustment described here in conjunction with a fluorescent dye or, respectively, fluorescent dyes.

According to WO 03/052315, the transmittance (DIN 5036) of a light-scattering cover provided with a base colour by means of one or more non-fluorescent dyes is at least 35% at the wavelength of the relative energy maximum of the light-emitting diode used, and its reflectance (DIN 5036) is at least 15%.

In the case of the inventive addition of one or more fluorescent dyes it is preferably advisable to adapt the base colour appropriately in comparison with WO 03/052315. The appropriate adaptation is generally needed in order to avoid large perpendicular deviations of the initial colour locus from the straight line which runs through the achromatic point (x/y=0.33/0.33) and through the colour locus of the LED, and thus to counteract colour shifts associated therewith.

A person skilled in the art can easily undertake this appropriate adaptation by correspondingly and appropriately adapting the concentration of the non-fluorescent dyes, generally slightly reducing the total amount or, for example, retaining only one in place of two non-fluorescent dyes and correspondingly changing the concentration of the remaining dyes. Suitable and appropriate adaptations are also apparent from comparison of the examples disclosed here with the non-examples.

Fluorescent Dye

The light-scattering cover composed of plastic comprises a base colour which has preferably been appropriately adapted in comparison with a base colour of the prior art, because of the presence of the fluorescent dye.

The appropriately adapted base colour with the associated fluorescent dye acts as a dye mixture to make the reflectance (DIN 5036) of the light-scattering cover at the wavelength of the energy maximum of the light-emitting diode used at least 28%, preferably at least 30%, particularly preferably at least 35%, and at the same time higher by at least 50% than the value that would be achieved with a (not appropriately adapted) base colour without a fluorescent dye. The colour-shade effect is therefore substantially more brilliant than can be achieved using a colour according to WO 03/052315. In particular, the colour locus of the reflected light is closer to the colour locus of the LED in an inventive light-scattering cover than in a corresponding cover of the prior art.

Suitable fluorescent dyes are in particular those fluorescent dyes which emit fluorescent light in the region of the wavelength of the energy maximum of the coloured LEDs used. The inventive effect can be achieved here by using surprisingly small amounts, e.g. using from 0.001 to 0.01% by weight, based on the plastic of the light-scattering covers.

Examples of suitable fluorescent dyes are those based on perylene or on perylene derivatives, e.g. fluorescent dyes available from BASF with the trade mark Lumogen®.

Addition of a yellow-fluorescent dye, preferably of a yellow-fluorescent perylene dye, in particular of the fluorescent dye Lumogen® F Yellow 170 is suitable for light-scattering covers whose base colour is yellow.

Addition of a red-fluorescent dye, preferably of a red-fluorescent perylene dye, in particular of the fluorescent dye Lumogen® F Red 305 or Lumogen® F Pink 285 is suitable for light-scattering covers whose base colour is red.

Addition of a green-fluorescent dye, preferably of a green-fluorescent perylene dye, in particular of the fluorescent dye Lumogen® F Yellow 083 or Lumogen® F Yellow 170 is suitable for light-scattering covers whose base colour is green.

Addition of a blue-fluorescent dye, preferably of a blue-fluorescent perylene dye, in particular of the fluorescent dye Lumogen® F Violet 570 or Lumogen® F Blue 650 is suitable for light-scattering covers whose base colour is blue.

A main difference from WO 03/052315 is that there has been a noticeable increase in the reflectance at the wavelength of the energy maximum of the light-emitting diode used, caused via the colour mixture composed of base colour and of at least one fluorescent dye associated with the base colour. It is surprising that this is successful without, or with only slight, alteration of the values for transmittance or the colour locus. When the appearance of the inventively used light-scattering cover is compared with that of a cover according to WO 03/052315 it again appears markedly more brilliant. The colour per se appears practically unaltered to the naked eye.

At the wavelength of the relative energy maximum of the light-emitting diode, the transmittance (DIN 5036, see Parts 1 and 3) of the inventively associated light-scattering cover composed of plastic is preferably at least 20%, with preference at least 35%, with preference at least 38%, particularly preferably at least 41% and its reflectance (DIN 5036, Part 1 and 3, reflectance or reflected light) is at least 28%, with preference at least 40%, particularly preferably at least 50%. The reflectance is advantageously higher by at least 50%, preferably by at least 75%, particularly preferably by at least 100%, than the value that would be achieved with a corresponding base colour of the prior art without fluorescent dye.

The transmittance of an inventive light-scattering cover is advantageously higher than that of a corresponding light-scattering cover of the prior art (see Tables 4 and 5).

In the case of an inventively yellow-coloured light-scattering cover the transmittance rises in comparison by from about 1 to 2%.

In the case of an inventively red-coloured light-scattering cover the transmittance rises in comparison by from about 30 to 35%.

In the case of an inventively green-coloured light-scattering cover the transmittance rises in comparison by from about 15 to 25%.

In the case of an inventively blue-coloured light-scattering cover the transmittance rises in comparison by from about 7 to 15%.

In particular, the transmittance of a light-scattering cover associated with a yellow LED can be at least 50%, preferably at least 60%. The corresponding reflectance can be at least 28%, preferably at least 30%, in particular at least 40%.

In particular, the transmittance of a light-scattering cover associated with a red LED can be at least 40%, preferably at least 45%. The corresponding reflectance can be at least 28%, preferably at least 45%.

In particular, the transmittance of a light-scattering cover associated with a green LED can be at least 40%, preferably at least 42%. The corresponding reflectance can be at least 28%, preferably at least 30%, in particular at least 40%.

In particular, the transmittance of a light-scattering cover associated with a blue LED can be at least 40%, preferably at least 42%. The corresponding reflectance can be at least 25%, preferably at least 30%.

If LEDs of different colour are used simultaneously, in order to obtain mixed colours, e.g. yellow and green LEDs, giving a yellowish green perceived colour, the intention is that the associated light-scattering cover composed of plastic have, at least at the wavelength of the relative energy maximum of one of the light-emitting diodes used, e.g. of the yellow or of the green LED, the reflectance values demanded above and preferably also the transmittance values stated above.

The associated light-scattering cover is composed of a plastic which is a plastic which in the uncoloured state and without scattering agents is transparent or, respectively, whose transmittance (DIN 5036, see Parts 1 and 3/D65) is preferably at least 50%, with preference at least 70%, particularly preferably from 75 to 92%. However, with scattering agent and without colorant the transmittance can advantageously amount to at least 40%, particularly preferably at least 50%.

Examples of suitable plastics are polymethyl methacrylate, impact-modified polymethyl methacrylate, polycarbonate, polystyrene, styrene-acrylonitrile, polyethylene terephthalate, glycol-modified polyethylene terephthalate, polyvinyl chloride, transparent polyolefin, acrylonitrile-butadiene styrene (ABS) or a mixture (blend) of various thermoplastics.

Particularly for outdoor applications, polymethyl methacrylate plastics composed of cast or extruded polymethyl methacrylate, e.g. with a methyl methacrylate content of from 85 to 100% by weight, are preferred, because they have high weathering resistance. Up to 15% by weight of suitable comonomers can, if appropriate, be polymerized concomitantly or can be present in the polymer, examples being esters of methacrylic acid (e.g. ethyl methacrylate, butyl methacrylate, hexyl methacrylate, cyclohexyl methacrylate), esters of acrylic acid (e.g. methyl acrylate, ethyl acrylate, butyl acrylate, hexyl acrylate, cyclohexyl acrylate) or styrene and styrene derivatives, such as α-methylstyrene or p-methyl-styrene.

The light-scattering coefficient of the cover, measured to DIN 5036, can preferably be at least 0.5, particularly preferably at least 0.6, in particular at least 0.7. As the light-scattering coefficient rises, the achievable distances between LEDs and the cover become smaller, as also do the apparatus installation depths associated therewith.

Light-Scattering Agents

Examples of light-scattering agents that can be used are BaSO₄, polystyrene or light-scattering beads composed of a crosslinked plastic.

Preference is given to BaSO₄ or polystyrene, their amount introduced into the plastic preferably being from 1.5 to 2.5% by weight.

It is preferable that an amount of from 0.1 to 10% by weight of light-scattering beads composed of a crosslinked plastic is introduced into the plastic.

The requirement for high transmittance with a high level of light-scattering is difficult to meet. A high scattering coefficient is achieved via titanium dioxide. However, since this colorant reflects much of the light, only low light permeabilities are possible. Colourless scattering pigments whose refractive index deviates by up to about 0.2 from the refractive index of the acrylic sheet are more advantageous. Examples of suitable materials are calcium carbonate, magnesium carbonate, aluminium trihydroxide, magnesium hydroxide, barium sulphate, etc.

It is also possible to use polymers whose refractive index is in the suitable range. By way of example, polystyrene can be dissolved in methyl methacrylate monomer and then precipitates during the polymerization and leads to a material with good light-scattering. However, it is also possible to add crosslinked polymer particles, an example being polymer beads composed of crosslinked polystyrene, another example being crosslinked copolymers composed of methyl methacrylate with phenyl (meth)acrylate or benzyl (meth)acrylate.

Production of Coloured Light-Scattering Cover Composed of Plastic

Scattering agents and colorants can be added to or, respectively, incorporated into the plastic in a manner known per se during the production process via polymerization within the polymerizable mixture (cast production process) or during thermoplastic processing of the polymer in the melt, e.g. by means of extrusion or injection moulding. The materials manufactured can take the form of sheets or else of any desired profiles, such as pipes, rods, etc.

This method can give, for example, plastic sheets, for example with a thickness of from 0.5 to 10 mm, preferably from 1 to 5 mm, and these can be used as covers for inventive illuminable apparatuses with rectangular boxes, frames or a holder. Corresponding sections can also be adapted appropriately and converted into practically any desired shapes via cutting, milling, sawing or other mechanical operations.

Colorants for the Base Colour

Suitable non-fluorescent colorants for the base colour for the purposes of the invention are preferably non-fluorescent organic colorants, because these have high brilliance and luminosity not only when front-lit but also when back-lit. Light stabilizers, UV absorbers, antioxidants, etc. can also be added in order to protect the acrylic sheet from the effects of light and weathering.

Colorants that can particularly be used in plastic are non-fluorescent soluble dyes or non-fluorescent organic pigments, but also less preferably insoluble inorganic colour pigments. Examples that may be mentioned are:

For yellow colours: pyrazolone yellow or perinone orange or a mixture thereof.

For red colours: mixtures composed of pyrazolone yellow or anthraquinone red or naphthol AS or DPP red or a mixture thereof.

For green colours: Cu phthalocyanine green or pyrazolone yellow or a mixture thereof.

For blue colours: anthraquinone blue or ultramarine blue or a mixture thereof.

Standard Chromaticity Diagram

The DIN 5033 standard chromaticity diagram is very well known to the person skilled in the art. The DIN 5033 standard chromaticity diagram permits unambiguous classification of the colours of light sources and of objects (e.g. for paints, light filters, etc.) according to their chromaticity.

The classification requires measurements of the chromaticity coordinates x and y; the coordinates therefore determine unambiguously the colour locus for a given chromaticity (e.g. red, green, yellow or blue or colour mixtures). Appropriate colour measurements can be made using commercially available colour-measurement devices. These colour-measurement devices generally permit contactless measurement of light sources and of colours of objects. An example of a suitable device is the CS-100 Chroma-Meter® colour-measurement device from Minolta, or else corresponding devices from other manufacturers.

The standard chromaticity diagram represents a shoe-sole-shaped area within a system of x and y coordinates. Each point on this shoe-sole-shaped area of the chromaticity diagram unambiguously represents a single chromaticity. Colours of the same chromaticity have the same colour locus with identical x and y coordinates and can differ only in their lightness.

In the central region of the standard chromaticity diagram is what is known as the achromatic point with coordinates x=0.33 and y=0.33. The achromatic point represents, depending on lightness, white or grey to black. All of the other (non-neutral) chromaticities lie between the achromatic point and the parameter curve of the shoe-sole-shaped area of the standard chromaticity diagram. Each of the lines emanating from the achromatic point comprises the colours of identical colour shade with increasing saturation or, respectively, increasing brilliance, i.e. from unsaturated to saturated or, respectively, brilliant. This is the rule underlying the standard chromaticity diagram.

The parameter curve of the shoe-sole-shaped area of the standard chromaticity diagram arises from the spectral colour curve and what is known as the purple boundary. As a chromaticity defined via its x and y coordinates becomes more remote at the parameter of the shoe-sole-shaped area of the standard chromaticity diagram its appearance becomes more brilliant. By way of example, the coordinates x=0.02, y=0.7 represent a brilliant green; the coordinates x=0.7, y=0.26 represent a brilliant red; the coordinates x=0.18, y=0.02 represent a brilliant blue.

Colour Loci

The invention is based on the concept that as the colour locus of the reflected light from the coloured cover approaches the colour locus of LED, the perceived front-lit and back-lit colour should come into closer agreement. However, it has been found that in practice it is possible only to achieve an approximation to agreement of a colour with a prescribed LED colour locus. Deviations which are on or close to the straight line which runs through the achromatic point (x/y=0.33/0.33) and the colour locus of the LED can generally be better tolerated than deviations which, although of the same magnitude, are further removed from the straight line described.

It is desirable that the location of the colour loci be if possible at the margin of the standard chromaticity diagram (see, for example, DIN 5033 or corresponding standard references), because this is where the brilliance of the colour is at its greatest. The fact that, by virtue of the monochromatic light, the colour loci of the LEDs are likewise at the margin or close to the margin of the standard chromaticity diagram also leads to this conclusion.

In many cases it is not possible to achieve corresponding colours with one colorant alone. A factor to be considered in the case of mixtures is that the individual components are not excessively separated from one another on the standard chromaticity diagram, because then the mixed hue can have insufficient brilliance.

Based on the standard chromaticity diagram (see, for example, DIN 5033 or corresponding standard references) and the colour loci of reflected light from the light-scattering cover and on the colour locus of the LED(s) used, the following alternative relationship applies (in which connection see Example 6) between the absolute value and of difference between the x value of the light-scattering cover and the x value of the LED and the absolute value of the difference between the y value of the light-scattering cover and the y value of the LED:
a) for blue LED illumination: x smaller than 0.03/y smaller than 0.05
b) for green LED illumination: x smaller than 0.05/y smaller than 0.08
c) for yellow LED illumination: x smaller than 0.0025/y smaller than 0.02
d) for red LED illumination: x smaller than 0.03/y smaller than 0.003

The method of measurement of the colour locus of the reflected light from the light-scattering cover consists in illuminating, from above at a distance of 60 cm, the light-scattering cover in front of a white background (e.g. a white-painted box, see the examples) using a daylight 150 W lamp (D65 to DIN 6173, class 1 quality, e.g. from Siemens) and measuring the colour from a distance of 100 cm, likewise from above. Measurement devices are available to the person skilled in the art for measurement of colour loci. By way of example, the colour can be measured using the CS-100 Chroma-Meter colour-measurement device from Minolta. The colour locus of the LED can be calculated, for example, from its emission spectrum, or is known from the manufacturer's data.

Apparatus for Yellow (or Yellowish-Green) Illumination

The LEDs used can, for example, emit yellow (or yellowish-green) light and their colour locus can be within the range of coordinates x/y=(0.5/0.5)+/−0.02.

In this case, the plastic of the cover can comprise a base colour composed of a mixture composed of from 0.075 to 0.09% by weight, preferably from 0.081 to 0.084% by weight, of pyrazolone yellow and from 0.002 to 0.004% by weight, preferably from 0.0028 to 0.0032% by weight, of perinone orange. A fluorescent dye is also present, preferably a fluorescent dye based on perylene, particularly preferably the fluorescent dye Lumogen® Yellow 170 (BASF), preferably at a concentration of from 0.005 to 0.015% by weight.

It is advantageous to combine this colour with BaSO₄ as scattering agent, its amount being from 1.5 to 2.5% by weight.

Apparatus for Red Illumination

The LEDs used can, for example, emit red light and their colour locus can be within the range of coordinates x/y=(0.67/0.33)+/−0.02.

In this case, the plastic of the cover can comprise a base colour composed of from 0.2 to 0.3% by weight, preferably from 0.22 to 0.28% by weight, of pyrazolone yellow. A fluorescent dye is also present, preferably a fluorescent dye based on perylene, particularly preferably the fluorescent dye Lumogen® F Red 305 (BASF), preferably at a concentration of from 0.0025 to 0.0075% by weight.

It is advantageous to combine this colour with polystyrene as scattering agent, its amount being from 1.5 to 2.5% by weight.

Apparatus for Green Illumination

The LEDs used can, for example, emit green light and their colour locus can be within the range of coordinates x/y=(0.16/0.73)+/−0.02.

In this case, the plastic of the cover can comprise a base colour composed of from 0.03 to 0.05% by weight, preferably from 0.035 to 0.045% by weight, of Cu phthalocyanine green. A fluorescent dye is also present, preferably a fluorescent dye based on perylene, particularly preferably the fluorescent dye Lumogen® F Yellow 083 (BASF), preferably at a concentration of from 0.01 to 0.03% by weight.

It is advantageous to combine this colour with BaSO₄ or polystyrene as scattering agent, its amount being from 1.5 to 2.5% by weight.

Apparatus for Blue Illumination

The LEDs used can, for example, emit blue light and their colour locus can be within the range of coordinates x/y=(0.14/0.06)+/−0.02.

The plastic of the cover can also have been coloured with from 0.005 to 0.015% by weight, preferably from 0.007 to 0.012% by weight, of anthraquinone blue. A fluorescent dye is also present, preferably a fluorescent dye based on perylene, particularly preferably the fluorescent dye Lumogen® F Violet 570 (BASF), preferably at a concentration of from 0.05 to 0.15% by weight.

It is advantageous to combine this colour with polystyrene as scattering agent, its amount being from 1.5 to 2.5% by weight.

Addition of TiO₂

In one preferred embodiment, the plastic of the cover also comprises TiO₂ at a concentration of from 0.001 to 0.05% by weight. This can achieve a further increase in the reflectance value by from about 2 to 10%. The naked eye discerns a further very marked increase in the brilliance of the colour.

Uses

The inventive apparatus uses, as cover, the coloured plastics elements described, comprising a scattering agent, and uses, as light source, coloured LEDs.

Illuminance Values

The front-lit illuminance values Y in Cd/m² measured (see Example 6) are as follows for inventively coloured light-scattering covers:

in the case of covers for blue LED illumination greater than or equal to 12.5 Cd/m²,

in the case of covers for green LED illumination greater than or equal to 30 Cd/m², preferably greater than or equal to 40 Cd/m², particularly preferably greater than or equal to 50 Cd/m²,

in the case of covers for yellow LED illumination greater than or equal to 100 Cd/m², preferably greater than or equal to 110 Cd/m², particularly preferably greater than or equal to 120 Cd/m²,

in the case of covers for red LED illumination greater than or equal to 25 Cd/m², preferably greater than or equal to 30 Cd/m², particularly preferably greater than or equal to 40 Cd/m².

The method of measurement of the luminance Y in Cd/m² of the light-scattering cover consists in illuminating, from above at a distance of 60 cm, the light-scattering cover in front of a white background (e.g. a white-painted box, see the examples) using a daylight 150 W lamp (D65 to DIN 6173, class 1 quality, e.g. from Siemens) and measuring the luminance from a distance of 100 cm, likewise from above. Measurement devices are available to the person skilled in the art for measurement of illuminance values. An example of a device which can be used for the illuminance measurement is the CS-100 Chroma-Meter colour-measurement device from Minolta, which measures colour loci and illuminance values.

### Examples

### Example 1

### Light-Scattering Cover with the Inventive Colours Red 1, Yellow 1, Blue 1 and Green 1

1 part of 2,2′-azobis(2,4-dimethylvaleronitrile) is dissolved in 1000 parts of prepolymeric methyl methacrylate syrup (viscosity about 1000 cp).

A colour paste composed of the following is added to this mixture:

3 parts of a soluble polymethyl methacrylate resin,

20 parts of barium sulphate and the colorants according to Table 1, the paste being dispersed with a high-speed disperser (rotor/stator principle) in 30 parts of methyl methacrylate.

The mixture is vigorously stirred, charged to a silicate glass cell with a distance of 3 mm thickness as spacer, and polymerized for about 16 hours in a water bath at 45° C. The final polymerization takes place during about 4 hours in a heat-conditioning cabinet at 115° C.

Colorants: see Table 1

### Example 2

### Light-Scattering Cover with the Inventive Colours Red 2, Yellow 2, Blue 2 and Green 2

Production as in Example 1 but using the colorants according to Table 2

### Comparative Examples

### Light-Scattering Cover with the Non-Inventive Colours Red 3, Yellow 3, Blue 3 and Green 3

Production as in Example 1, but with the colorants according to Table 3

TABLE 1

| | Cu phthalocyanine | Pyrazolone | Anthraquinone | Perinone | |
|---|---|---|---|---|---|
| Colour | green | yellow | blue | orange | Lumogen |
| Red 1 | — | 0.25 | — | — | 0.005 F Red 305 |
| Green 1 | 0.04 | — | — | — | 0.020 F Yellow 083 |
| Blue 1 | — | — | 0.01 | — | 0.100 F Violet 570 |
| Yellow 1 | — | 0.0825 | — | 0.003 | 0.010 F Yellow 170 |

Data in % by weight

TABLE 2

| | Cu phthalocyanine | Pyrazolone | Anthraquinone | Perinone | Titanium | |
|---|---|---|---|---|---|---|
| Colour | green | yellow | blue | orange | dioxide | Lumogen |
| Red 2 | — | 0.25 | — | — | 0.0075 | 0.005 F Red 305 |
| Green 2 | 0.04 | — | — | — | 0.0075 | 0.020 F Yellow 083 |
| Blue 2 | — | — | 0.01 | — | 0.0075 | 0.100 F Violet 570 |
| Yellow 2 | — | 0.0825 | — | 0.003 | 0.0075 | 0.010 F Yellow 170 |

Data in % by weight

TABLE 3

| | Cu phthalocyanine | Pyrazolone | Anthraquinone | Perinone | Anthraquinone | Anthraquinone |
|---|---|---|---|---|---|---|
| Colour | green | yellow | blue | orange | violet | red |
| Red 3 | — | 0.1500 | — | — | — | 0.0200 |
| Yellow 3 | — | 0.0825 | — | 0.003 | — | — |
| Green 3 | 0.0200 | 0.0400 | — | — | — | — |
| Blue 3 | — | — | 0.0100 | — | — | — |

Data in % by weight

### Examples 4 (Inventive) and 5 (Comparative Example)

Colour Measurements and Illuminance Values

In each case, the internal base of a white-painted sheet-metal box of dimensions 90×470 mm and height 100 mm, open at the top, has 32 light-emitting diodes attached, e.g. from OSRAM (8 modules of 4 LEDs). (Standard LEDs of mutually comparable colour shade are available from many manufacturers). The permissible operating current of from 320 to 400 mA, depending on type, is set using a power supply unit with an operating voltage of 10 V.

The samples described above are placed on this box and assessed for colour. The front-lit test (daytime effect) uses illumination with a 150 W daylight lamp (D65 to DIN 6173, class 1 quality, e.g. from Siemens) from above at a distance of about 60 cm, the LEDs having been switched off. The back-lit test takes place in a darkened room with LEDs switched on according to above operating information. The colour measurements are carried out using CS-100 Chroma-Meter colour-measurement equipment from Minolta. This equipment permits contactless measurements of light sources and of colours of objects. The distance between specimen and device is 1 m. Illuminance Y in Cd/m² is also measured here using this device.

The results of the colour measurements and illuminance values with LED back-lighting (colour loci for transmitted light) for the light-scattering covers according to Examples 1 and 2 are shown in Table 4. Table 5 shows, for comparison, corresponding colour measurements and illuminances from the comparative experiments from Example 3.

### Example 4

TABLE 4
(inventive colourings of Examples 1 and 2)

| | LED λmax in | Transmittance at | Reflectance at | | | |
|---|---|---|---|---|---|---|
| Colour | nm | LED λmax | LED λmax | Y in Cd/m² | x | y |
| Yellow 1 | 590 | 64% | 40% | 130 | 0.550 | 0.449 |
| Yellow 2 | 590 | 63% | 46% | 133 | 0.550 | 0.448 |
| Red 1 | 620 | 80% | 56% | 165 | 0.687 | 0.312 |
| Red 2 | 620 | 79% | 63% | 162 | 0.687 | 0.312 |
| Green 1 | 520 | 66% | 46% | 38.8 | 0.143 | 0.780 |
| Green 2 | 520 | 61% | 52% | 36.1 | 0.143 | 0.782 |
| Blue 1 | 440 | 56% | 36% | 6.32 | 0.138 | 0.046 |
| Blue 2 | 440 | 52% | 41% | 6.34 | 0.138 | 0.045 |

### Example 5

TABLE 5
(non-inventive colours, see Example 3)

| | LED λmax in | Transmittance at | Reflectance at | | | |
|---|---|---|---|---|---|---|
| Colour | nm | LED λmax | LED λmax | Y in Cd/m² | x | y |
| Yellow 3 | 590 | 62% | 26% | 127 | 0.545 | 0.453 |
| Red 3 | 620 | 48% | 23% | 165 | 0.684 | 0.315 |
| Green 3 | 520 | 43% | 19% | 36.3 | 0.143 | 0.782 |
| Blue 3 | 440 | 43% | 21% | 6.34 | 0.138 | 0.045 |

The results (Table 4) show that when coloured acrylic sheets produced using the above procedure are compared with the colours corresponding (Table 5) to the prior art they differ only insignificantly from one another in colour locus of transmitted light with LED back-lighting (night-time effect). The light scattering is so good that uniform illumination is achieved at a distance of only 40 mm from the LED.

If the colour coordinates according to Table 4 are entered into the standard chromaticity diagram (see, for example DIN 5033 or corresponding standard references), it can be seen that the values (and therefore the colour shades) lie within the limits demanded by the invention close to the line of the wavelength for the same colour shade (line between achromatic point and colour locus of the respective LED colour). The good agreement of the colour shade is discernible in a front- and back-lit visual test.

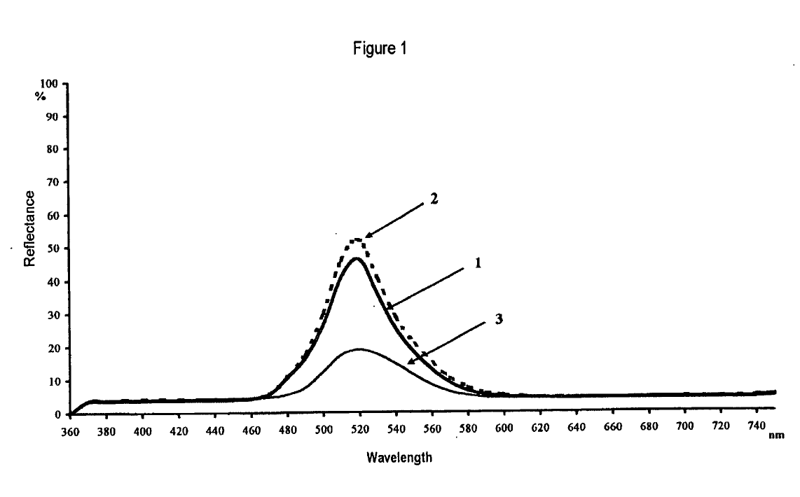

According to FIG. 1/2 for green LEDs it can be seen that at 520 nm (energy maximum for green LEDs) the reflectance for the colour green 1 and green 2 is markedly above the value for the comparative experiment without fluorescent dye (green 3). The reflectance values in these regions are markedly above the 28% demanded and are above the value for the comparative experiment green 3 by more than 50%.

The results of the front-lit colour measurements and illuminance values (colour loci of reflected light) for the light-scattering covers according to Examples 1 and 2 are shown in Table 6. Table 7 shows, for comparison, corresponding colour measurements and illuminance values from the comparative experiments from Example 3.

The results for the illuminance values Y in Cd/m² (Table 6) show that markedly higher front-lit brilliance values (daylight effect) are achieved by the coloured acrylic sheets produced by the above procedure, when comparison is made with the colours corresponding (Table 7) to the prior art.

### Example 6

TABLE 6
(inventive colours from Examples 1 and 2)

| | | | | Absolute | Absolute |
|---|---|---|---|---|---|
| | | | | value of x | value of y |
| | Y in | | | LED - | LED - |
| Colour | Cd/m² | x | y | x specimen | y specimen |
| LED blue | — | 0.14 | 0.06 | | |
| Blue 1 | 12.6 | 0.168 | 0.107 | 0.028 | 0.047 |
| Blue 2 | 13.1 | 0.166 | 0.105 | 0.026 | 0.045 |
| LED green | — | 0.16 | 0.73 | | |
| Green 1 | 59.3 | 0.194 | 0.661 | 0.034 | 0.069 |
| Green 2 | 62.3 | 0.19 | 0.673 | 0.030 | 0.057 |
| LED yellow | — | 0.5 | 0.5 | | |
| Yellow 1 | 123 | 0.498 | 0.485 | 0.002 | 0.015 |
| Yellow 2 | 126 | 0.499 | 0.485 | 0.001 | 0.015 |
| LED red | — | 0.67 | 0.33 | | |
| Red 1 | 41.8 | 0.655 | 0.328 | 0.015 | 0.002 |
| Red 2 | 43.1 | 0.66 | 0.329 | 0.010 | 0.001 |

### Example 7

TABLE 7
(non-inventive colours, see Example 3)

| | | | | Absolute | Absolute |
|---|---|---|---|---|---|
| | | | | value of x | value of y |
| | Y in | | | LED - | LED - |
| Colour | Cd/m² | x | y | x specimen | y specimen |
| LED blue | — | 0.14 | 0.06 | | |
| Blue 3 | 12.1 | 0.176 | 0.128 | 0.036 | 0.068 |
| LED green | — | 0.16 | 0.73 | | |
| Green 3 | 28 | 0.221 | 0.628 | 0.061 | 0.102 |
| LED yellow | — | 0.5 | 0.5 | | |
| Yellow 3 | 97.5 | 0.497 | 0.485 | 0.003 | 0.015 |
| LED red | — | 0.67 | 0.33 | | |
| Red 3 | 23.7 | 0.636 | 0.327 | 0.034 | 0.003 |

1. Apparatus for illumination with blue, green, yellow or red light-emitting diodes (LEDs), comprising one or more coloured LEDs and a light-scattering cover associated with the LED colour and composed of coloured plastic and having a base colour derived from one or more non-fluorescent dyes, characterized in that
the light-scattering cover comprises, in addition to the base colour, at least one fluorescent dye associated in terms of colour with the base colour, where the dye mixture has been adjusted in such a way that the reflectance of the light-scattering cover is at least 28% at the wavelength of the energy maximum of the LED(s) used, where, based on the standard chromaticity diagram and on the colour loci of the reflected light from the light-scattering cover and on the colour locus of the LED(s) used, the following alternative relationship applies to the absolute value of the difference between the x value of the light-scattering cover and the x value of the LED and the absolute value of the difference between the y value of the light-scattering cover and the y value of the LED:
a) for blue LED illumination: absolute value for x smaller than 0.03/absolute value for y smaller than 0.05
b) for green LED illumination: absolute value for x smaller than 0.05/absolute value for y smaller than 0.08
c) for yellow LED illumination: absolute value for x smaller than 0.0025/absolute value for y smaller than 0.02
d) for red LED illumination: absolute value for x smaller than 0.03/absolute value for y smaller than 0.003.

2. Apparatus according to claim 1, characterized in that a fluorescent dye is present which emits light in the region of the wavelength of the energy maximum of the coloured LEDs used.

3. Apparatus according to claim 1, characterized in that a fluorescent dye is present which is a perylene derivative.

4. Apparatus according to claim 1, characterized in that the separation between the LEDs and the light-scattering cover is from 3 to 12 cm.

5. Apparatus according to claim 1, characterized in that the light-scattering cover is composed of a cast or extruded polymethyl methacrylate plastic.

6. Apparatus according to claim 1, characterized in that the light-scattering coefficient, measured to DIN 5036, of the plastic of the cover is at least 0.5.

7. Apparatus according to claim 6, characterized in that the light-scattering agent present comprises BaSO₄, polystyrene or light-scattering beads composed of a crosslinked plastic.

8. Apparatus according to claim 7, characterized in that the light-scattering agent used comprises an amount of from 1.5 to 2.5% by weight of BaSO₄ or polystyrene.

9. Apparatus according to claim 1, characterized in that the location of the LEDs is in a box or frame which is covered by the light-scattering cover.

10. Apparatus according to claim 1, characterized in that the colour loci of the transmitted and the reflected light from the coloured cover composed of plastic, based on the standard chromaticity diagram, are in a region whose distance, based on a straight line which runs through the achromatic point (x/y=0.33/0.33) and through the colour locus of the LED, is not more than 0.2 x/y units from the colour locus of the LED in the direction of the straight line and not more than 0.05 x/y units in the directions perpendicular to the two sides of the straight line.

11. Apparatus according to claim 1, characterized in that the LEDs emit yellow light and their colour locus is within the range of coordinates x/y=(0.5/0.5)+/−0.02.

12. Apparatus according to claim 11, characterized in that the base colour of the plastic of the cover uses from 0.075 to 0.09% by weight of pyrazolone yellow and from 0.002 to 0.004% by weight of perinone orange and also comprises the fluorescent dye Lumogen® F Yellow 170, at a concentration of from 0.005 to 0.015% by weight.

13. Apparatus according to claim 1, characterized in that the LEDs emit red light and their colour locus is within the range of coordinates x/y=(0.67/0.33)+/−0.02.

14. Apparatus according to claim 13, characterized in that the base colour of the plastic of the cover uses from 0.2 to 0.3% by weight of pyrazolone yellow and also comprises the fluorescent dye Lumogen® F Red 305, at a concentration of from 0.0025 to 0.0075% by weight.

15. Apparatus according to claim 1, characterized in that the LEDs emit green light and their colour locus is within the range of coordinates x/y=(0.16/0.73)+/−0.02.

16. Apparatus according to claim 15, characterized in that the base colour of the plastic of the cover uses from 0.03 to 0.05% by weight of Cu phthalocyanine green and also comprises the fluorescent dye Lumogen® F Yellow 083, at a concentration of from 0.01 to 0.03% by weight.

17. Apparatus according to claim 1, characterized in that the LEDs emit blue light and their colour locus is within the range of coordinates x/y=(0.14/0.06)+/−0.02.

18. Apparatus according to claim 17, characterized in that the base colour of the plastic of the cover uses from 0.005 to 0.015% by weight of anthraquinone blue and also comprises the fluorescent dye Lumogen® F Violet 570, at a concentration of from 0.05 to 0.15% by weight.

19. Apparatus according to claim 1, characterized in that the plastic of the cover also comprises TiO₂ at a concentration of from 0.001 to 0.05% by weight.

20. Apparatus according to claim 1, characterized in that the transmittance of the light-scattering cover is at least 20%.

21. A cover for an illuminable apparatus according to claim 1, characterized in that said cover comprises a coloured plastics element comprising a scattering agent.

22. A light source in an illuminable apparatus according to claim 1, comprising LEDs emitting coloured and, respectively, almost monochromatic light.
